(19) United States
(12) Patent Application Publication
(10) Pub. No.: US 2026/0270123 A1
(43) Pub. Date: Sep. 10, 2026

(54) MODULATION IDENTIFICATION

(71) Applicant: Amergint Technologies Inc., Colorado Springs, CO (US)

(72) Inventors: Wayne D. Music, Colorado Springs, CO (US); Andrew J. Smit, Colorado Springs, CO (US)

(21) Appl. No.: 19/347,226

(22) Filed: Oct. 1, 2025

Related U.S. Application Data
(60) Provisional application No. 63/702,140, filed on Oct. 1, 2024.

(51) Int. Cl. H04L 27/00; H04L 27/34

(52) U.S. Cl. CPC H04L 27/0012; H04L 27/34

(57) ABSTRACT

Systems include a receiver configured to detect signals corresponding to a stream of digital symbols, a signal decoder for processing the stream of digital symbols, and a computing device connected to the receiver and featuring a set of software instructions that, when executed by the computing device, causes the computing device to identify a modulation type associated with the stream of digital symbols, transmit a control signal to the signal decoder to configure the signal decoder based on the identified modulation type to process the stream of digital symbols, and use the configured signal decoder to decode at least a portion of the stream of digital symbols to extract encoded information based on the identified modulation type.

### CROSS-REFERENCE TO RELATED APPLICATIONS

This application claims priority to U.S. Provisional Patent Application No. 63/702,140, filed on Oct. 1, 2024, the entire contents of which are incorporated herein by reference.

### BACKGROUND

Radio-frequency communication systems receive signals that are modulated using a variety of signal space schemes. When known data bits are modulated in a particular grouping of bits, the detected symbol stream can typically be readily demodulated. However, in the absence of such a priori knowledge of modulation type employed, modulation type is unknown to the receiver and can present significant challenges, leading to a loss of information.

### SUMMARY

This disclosure features methods, systems, and tangible, computer-readable media with encoded instructions for determining the modulation type of a detected symbol stream. The methods, systems, and media use techniques that are blind—that is, determine the modulation type without a priori information that suggests or guides the determination. The techniques are based on the use of higher-order cumulants (HOCs) to develop hierarchical decision trees that effectively separate different possible modulation types based on combinations of cumulant magnitudes associated with the different modulation types. The techniques can be applied to a wide variety of different modulation types, with a unique combination of cumulant magnitudes acting as a type of “fingerprint” for each different modulation type.

In an aspect, the disclosure features systems that include a receiver configured to detect signals corresponding to a stream of digital symbols, a signal decoder for processing the stream of digital symbols, and a computing device connected to the receiver and featuring a set of software instructions that, when executed by the computing device, causes the computing device to: identify a modulation type associated with the stream of digital symbols by computing values of a set of cumulant-based measures for at least a subset of the stream of digital symbols, comparing the computed values to expected ranges for the set of cumulant-based measures for a plurality of candidate modulation types, and blindly identifying the modulation type associated with the stream of digital symbols from among the candidate modulation types based on the comparison; transmit a control signal to the signal decoder to configure the signal decoder based on the identified modulation type to process the stream of digital symbols; and use the configured signal decoder to decode at least a portion of the stream of digital symbols to extract encoded information based on the identified modulation type.

Embodiments of the systems can include any one or more of the following features.

Blindly identifying the modulation type associated with the stream of digital symbols can include, for each modulation type of the plurality of candidate modulation types, excluding the modulation type if any of the computed values of the cumulant-based measures is outside a corresponding range of expected values for the modulation type. Blindly identifying the modulation type associated with the stream of digital symbols can include identifying among the plurality of candidate modulation types a single modulation type associated with the stream of digital symbols. Blindly identifying the modulation type associated with the stream of digital symbols can include identifying among the plurality of candidate modulation types a set of candidate modulation types, where the set of candidate modulation types includes fewer members than the plurality of candidate modulation types. The set of candidate modulation types can include three or fewer members.

The set of cumulant-based measures can include one or more measures based on fourth-order cumulants. The set of cumulant-based measures can include one or more measures based on sixth-order cumulants. The set of cumulant-based measures can include one or more measures based on eighth-order cumulants.

The plurality of candidate modulation types can include at least 3 different modulation types (e.g., at least 7 different modulation types). The plurality of candidate modulation types can include one or more modulation types that correspond to phase-shift keying modulation. The plurality of candidate modulation types can include one or more modulation types that correspond to quadrature amplitude modulation. The plurality of candidate modulation types includes BPSK, QPSK, 8PSK, 16APSK, 32APSK, 8QAM, and 16QAM modulation types.

The set of cumulant-based measures can include at least 3 different cumulant-based measures (e.g., at least 10 different cumulant-based measures). At least one of the cumulant-based measures can include a magnitude of a cumulant value computed for the at least a subset of the stream of digital symbols. At least one of the cumulant-based measures can include a ratio of magnitudes of different cumulant values computed for the at least a subset of the stream of digital symbols. At least one of the cumulant-based measures can include a value of a linear function of a cumulant computed for the at least a subset of the stream of digital symbols. At least one of the cumulant-based measures can include a value of a nonlinear function of a cumulant computed for the at least a subset of the stream of digital symbols.

Embodiments of the systems can also include any other features described herein, including combinations of features described in connection with different embodiments, without limitation unless expressly stated otherwise.

In another aspect, the disclosure features methods that include detecting signals corresponding to a stream of digital symbols, computing values of a set of cumulant-based measures for at least a subset of the stream of digital symbols, comparing the computed values to expected ranges for the set of cumulant-based measures for a plurality of candidate modulation types, identifying a modulation type associated with the stream of digital symbols from among the candidate modulation types based on the comparison, configuring a signal decoder to configure the signal decoder based on the identified modulation type to process the stream of digital symbols, and using the configured signal decoder to decode at least a portion of the stream of digital symbols to extract encoded information based on the identified modulation type.

Embodiments of the methods can include any one or more of the following features.

Identifying the modulation type associated with the stream of digital symbols can include, for each modulation type of the plurality of candidate modulation types, excluding the modulation type if any of the computed values of the cumulant-based measures is outside a corresponding range of expected values for the modulation type. Identifying the modulation type associated with the stream of digital symbols can include identifying among the plurality of candidate modulation types a single modulation type associated with the stream of digital symbols. Identifying the modulation type associated with the stream of digital symbols can include identifying among the plurality of candidate modulation types a set of candidate modulation types, where the set of candidate modulation types includes fewer members than the plurality of candidate modulation types. The set of candidate modulation types can include three or fewer members.

The set of cumulant-based measures can include one or more measures based on fourth-order cumulants. The set of cumulant-based measures can include one or more measures based on sixth-order cumulants. The set of cumulant-based measures can include one or more measures based on eighth-order cumulants. The plurality of candidate modulation types can include at least 3 different modulation types (e.g., at least 7 different modulation types).

The plurality of candidate modulation types can include one or more modulation types that correspond to phase-shift keying modulation. The plurality of candidate modulation types can include one or more modulation types that correspond to quadrature amplitude modulation. The plurality of candidate modulation types can include BPSK, QPSK, 8PSK, 16APSK, 32APSK, 8QAM, and 16QAM modulation types.

The set of cumulant-based measures can include at least 3 different cumulant-based measures (e.g., at least 10 different cumulant-based measures). At least one of the cumulant-based measures can include a magnitude of a cumulant value computed for the at least a subset of the stream of digital symbols. At least one of the cumulant-based measures can include a ratio of magnitudes of different cumulant values computed for the at least a subset of the stream of digital symbols. At least one of the cumulant-based measures can include a value of a linear function of a cumulant computed for the at least a subset of the stream of digital symbols. At least one of the cumulant-based measures can include a value of a nonlinear function of a cumulant computed for the at least a subset of the stream of digital symbols.

Embodiments of the methods can also include any other features described herein, including combinations of features described in connection with different embodiments, without limitation unless expressly stated otherwise.

In another aspect, the disclosure features systems that include a receiver configured to detect signals corresponding to a stream of digital symbols, a signal decoder for processing the stream of digital symbols, and a computing device connected to the receiver and featuring a set of software instructions that, when executed by the computing device, causes the computing device to: identify a modulation type associated with the stream of digital symbols by computing values of a set of cumulant-based measures for at least a subset of the stream of digital symbols, constructing a feature vector associated with the at least a subset of the stream of digital symbols, where elements of the feature vector correspond to the set of cumulant-based measures, and identifying the modulation type associated with the stream of digital symbols from among the candidate modulation types by submitting the feature vector to a trained classifier that generates as output the modulation type associated with the stream of digital symbols; transmit a control signal to the signal decoder to configure the signal decoder based on the identified modulation type to process the stream of digital symbols; and use the configured signal decoder to decode at least a portion of the stream of digital symbols to extract encoded information based on the identified modulation type.

Embodiments of the systems can include any one or more of the features described herein, including combinations of features described in connection with different embodiments, without limitation unless expressly stated otherwise.

Unless otherwise defined, all technical and scientific terms used herein have the same meaning as commonly understood by one of ordinary skill in the art to which this disclosure belongs. Although methods and materials similar or equivalent to those described herein can be used in the practice or testing of the subject matter herein, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments are set forth in the accompanying drawings and the description below. Other features and advantages will be apparent from the description, drawings, and claims.

### BRIEF DESCRIPTION OF THE DRAWINGS

FIG. 1 is a schematic diagram showing a signal receiver and a plurality of signal transmitters.

FIG. 2 is a flow chart showing a set of example steps for performing a classification of modulation type for a symbol stream.

FIG. 3 is a flow chart showing a set of example steps for implementing the methodology shown in FIG. 2.

FIG. 4 is a flow chart showing another set of example steps for implementing the methodology shown in FIG. 2.

FIG. 5 is a graph showing the probability of correct identification of modulation type as a function of SNR for an incoming symbol stream.

FIG. 6 is a three-dimensional plot showing identified modulation types for a set of test signals.

FIG. 7 is a schematic diagram showing an example of a detection system.

FIG. 8 is a schematic diagram showing an example of a hierarchical decision tree based on higher-order cumulant values for a set of candidate modulation types.

FIG. 9A is a plot showing values of a cumulant-based feature calculated as a function of signal-to-noise ratio for different candidate modulation types.

FIG. 9B is a plot showing values of a different cumulant-based feature calculated as a function of signal-to-noise ratio for different candidate modulation types.

FIG. 10 is a schematic diagram showing an example signal decoder.

Like elements in the figures are labeled with common reference signs.

### DETAILED DESCRIPTION

### Introduction

In radio-frequency communication receiver systems, detection, estimation, and demodulation of received signals are critical to extracting information. In established networks of transmitters and receivers where the locations and transmission parameters of transmitters are well known, tracking and decoding symbol streams during uni-directional and bi-directional communication is comparatively easier. However, in many circumstances, signal monitoring is performed while a receiver is effectively blind to the modulation type of a signal. Further, a receiver may receive transmitted signals in which symbol streams are encoded with different modulation schemes, and/or with modulation schemes that may change over time, depending upon transmission conditions such as the distance between, and locations of, the source and receiver, the frequency band used for signal transmission, the power available to the source, channel conditions, and the nature of the information being encoded and transmitted. Additionally, synchronization errors (such as frequency offset and/or timing offsets and multi-path fading) may further complicate modulation determination for unknown symbol streams.

The techniques described herein permit blind modulation determination by using multiple HOCs to characterize the properties of a symbol stream of unknown modulation type, and a hierarchical classification based on combinations of cumulant magnitudes to distinguish among modulations of different types. The classification is based on a decision tree that allows for each different modulation type among a group of candidate modulation types to be uniquely identified. By computing HOC values for a detected symbol stream and then filtering the HOC values through the decision tree, the modulation type of the symbol stream can be determined without a priori knowledge of the modulation type.

The techniques described herein can be used to perform blind modulation classification of a symbol stream even in the presence of frequency offsets and/or symbol timing offsets between the receiver and the incoming symbol stream. HOCs are particularly amenable to such challenging detection scenarios, because fourth-order moments are insensitive to carrier frequency offsets, and because for a data set of a given size, the variance of fourth-order moments is generally smaller than variances associated with statistical features of second- and third-order. However, large frequency offsets are generally rectified prior to employment of cumulants. To determine modulation type associated with noisy signals (e.g., with relatively low signal-to-noise ratio), ranges of values for each computed cumulant measure that are associated with each of the different candidate modulations can be selected to ensure that a unique hierarchical decision path leads to each of the candidate modulations through the set of computed cumulant measures.

Cumulants and cyclostationary spectrum are used in practice to characterize symbol streams due to their relatively low complexity and robustness to model mismatches. However, for purposes of classifying modulation types, techniques based on these measures have previously demonstrated inferior performance compared to maximum likelihood (ML) approaches. To some extent, reduced classification performance can be offset by increasing the number of samples utilized. Nonetheless, low-order cyclostationary spectrum is generally incapable of distinguishing high-order phase shift keying (PSK) and quadrature amplitude modulation (QAM).

Accordingly, multiple cumulant-based measures form the basis for the classification techniques described herein. Cumulant-based classification hierarchies can discriminate among different classes of modulation schemes (e.g., PSK and QAM), and can also discriminate among different orders of the same modulation class (e.g., 16APSK versus 32APSK). Classification techniques based on multiple cumulant-based measures can also be extended as needed, with the number of cumulant-based measures increased effectively without limit to ensure that each different candidate modulation type can be distinguished. The techniques can also be readily adapted to accommodate new modulation types so that signals transmitted by a wide variety of different signal sources, in widely varying conditions, and modulating many different types of information, can be effectively demodulated and processed.

### Blind Modulation Identification

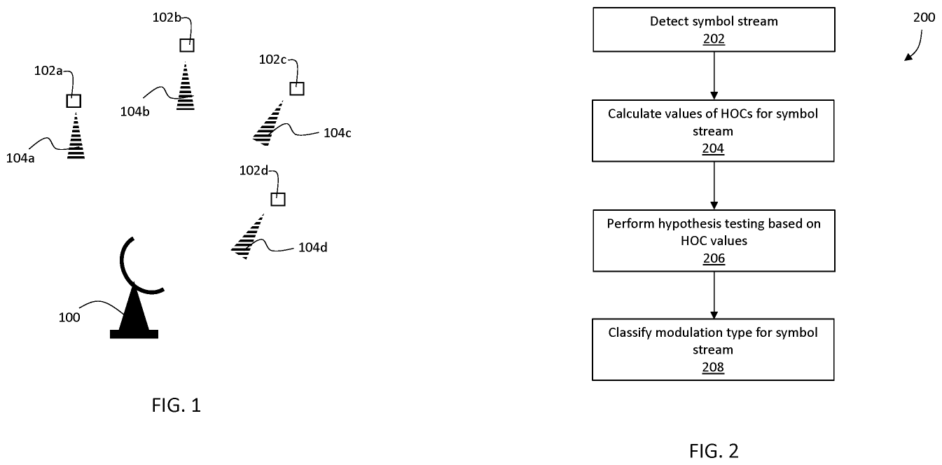

FIG. 1 is a schematic diagram showing a digital signal receiver 100 positioned to receive incoming digital signals in the form of a symbol stream. A plurality of signal transmitters 102a, 102b, 102c, . . . (where the number of such transmitters is unknown) transmits signals 104a, 104b, 104c, . . . (where the number of transmitted signals is unknown, and may be the same as, or different from, the number of transmitters). Transmitted signals reach receiver 100 and are detected as a stream of digital symbols.

In some embodiments, signal transmitters and receivers are paired 1:1. That is, each receiver 100 receives a symbol stream from a single signal transmitter. In contrast, in some embodiments, a receiver 100 can receive symbol streams from multiple signal transmitters.

In general, symbol streams are either modulated or unmodulated. Unmodulated symbol streams generally do not need to be classified as described herein, but determination of timing offset, phase offset, and frequency offset may still be important to synchronize the receiver to the incoming symbol stream.

More commonly, however, an incoming symbol stream is modulated according to a modulation type or scheme. Symbols from different signal transmitters may or may not have the same modulation scheme. The modulation type used by various transmitters may change over time due to factors such as the relative distance between signal transmitter and receiver, the amount of power available to the signal transmitter, the type of information that is transmitted, and the channel conditions in which signals are transmitted.

This disclosure features methods in which higher-order cumulant values for an incoming symbol stream are calculated and used to perform modulation type classification for the symbol stream. The general approach is illustrated in FIG. 2, which shows a flow chart 200 that includes a series of example steps for performing a classification of modulation type for a symbol stream.

In a first step 202, the incoming symbol stream is sampled by signal receiver 100 as described above. The number of symbols contained in the block of data can generally be adjusted as desired to ensure that the number of symbols detected is adequate to compute cumulant-based measures for the symbol stream (as will be discussed later) and to perform signal correction.

In step 204, values of one or more higher order cumulants (HOCs) are calculated for the sampled symbol stream. As will be explained in more detail subsequently, the HOCs are selected to permit different candidate modulation types for the sampled symbol stream to be distinguished from one another based on the values of the HOCs that are calculated.

Next, in step 206, hypothesis testing is performed based on the calculated HOC values. Hypothesis testing typically involves comparing the calculated HOC values to expected values of the HOCs for different modulation types. The comparisons can be performed as part of a hierarchical decision tree. By selecting appropriate sequences of HOCs to perform the comparisons, the hierarchical tree can distinguish among multiple different candidate modulation types uniquely.

Then, in step 208, the symbol stream's modulation type is classified based on the results of the hypothesis testing in step 206. As noted above, where hypothesis testing leads unambiguously to identification of only one possible modulation type from among multiple candidate modulation types, the symbol stream is classified as modulated with the identified modulation type.

To further describe the methods in this disclosure, the following specific examples showing implementation of the general set of steps shown in FIG. 2 are provided.

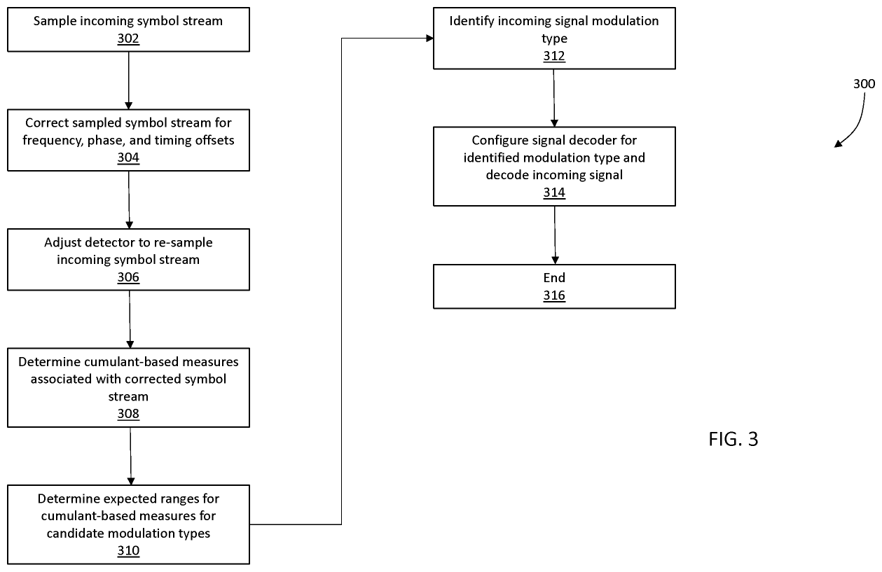

FIG. 3 shows a flow chart 300 that includes a series of example steps that can be performed to determine a modulation type associated with a detected signal. In the first step 302, the incoming symbol stream is sampled by signal receiver 100 as described above in connection with step 202 of FIG. 2. The number of symbols contained in the block of data can generally be adjusted as desired to ensure that the number of symbols detected is adequate to compute cumulant-based measures for the symbol stream (as will be discussed later) and to perform signal correction.

In the second step 304, the detected symbol stream is optionally corrected to account for errors such as frequency offset, symbol timing offset, and phase delay. In some embodiments, these errors may not be present, as signal receiver 100 may already have been adjusted to compensate for these errors. Thus, one or more of the frequency offset, symbol timing offset, and phase delay may be effectively minimized in the detected symbol stream.

In certain embodiments, however, the detected symbol stream is processed in step 304 to reduce or eliminate these sources of detection error. Particularly in circumstances where signal detection is effectively “blind”—that is, where the frequency and/or phase and/or timing offset of the incoming symbol stream are unknown, the unknown parameters are estimated as used to correct the detected symbol stream before the modulation type associated with the symbol stream is identified.

Different methods can be used to determine values of these parameters and to correct the detected symbol stream. In some embodiments, methods based on computing the complex Kurtosis of the symbol stream combined with polyphase filtering and/or minimum-Kurtosis searching can be used. Such methods are particularly useful in blind signal detection schemes and are described in U.S. Provisional Patent Application No. 63/701,914, filed on Oct. 1, 2024, the entire contents of which are incorporated by reference herein. These methods can be used to determine estimates of the carrier frequency offset and/or phase offset and/or timing delay which are then used in step 304 to correct the detected symbol stream to produce a corrected symbol stream.

In certain embodiments, instead of processing a detected symbol stream to generate a corrected symbol stream, the signal receiver can be adaptively adjusted to effectively re-sample the incoming symbol stream, such that the re-sampled sequence of symbols has reduced frequency offset and/or phase offset and/or timing delay. In optional step 306 of FIG. 3, signal receiver 100 is adjusted and the incoming symbol stream is re-sampled by the receiver. In some circumstances, re-sampling methods may require the detection of a larger number of symbols from an incoming signal than Kurtosis-based methods, and may therefore lead to a greater loss of information.

Methods for receiver adjustment and signal re-sampling include feedback-based methods such as phase-locked loops (PLLs). In a PLL, an incoming signal is sampled frequently and an estimate of the detected signal's phase is used to iteratively adjust a receiver's sampling frequency in an attempt to match the estimated signal. In some implementations, feedback-based methods may only converge after an incoming signal has been sampled for an extended period of time, which results in significant data loss due to missed symbols while the feedback algorithm is adjusting the detector. It may be difficult to detect symbol streams that are transmitted in burst modes using such methods, as such symbol streams may be too short for the feedback algorithm to optimize detection. Feedback-based methods may also be challenging to implement when transmission parameters such as frequency and/or phase of the incoming signal change relatively frequently, as the feedback algorithm must then adaptively re-converge based on the new set of transmission parameters. Feed-forward methods such maximum likelihood estimators can also be used for receiver adjustment and signal re-sampling. However, it has been observed in practice that for many incoming symbol streams, such methods may result in significant data loss, particularly for burst-mode communication and other short symbol streams. When feed-forward methods are used to detect symbol streams in burst-mode communications, effective detection typically relies on phase coherence between concatenated data fragments. When phase coherence is lost during signal propagation or when symbol transmission occurs with greater asynchronicity, feed-forward methods may be challenging to implement.

Whether the sampled incoming symbol stream from step 302 is essentially free from frequency, timing, and phase errors (and therefore, optional steps 304 and 306 are not performed), or the sampled incoming symbol stream from step 302 is corrected using estimates of frequency, timing, and/or phase errors (as in optional step 304), or the incoming symbol stream is re-sampled with the signal receiver adjusted to correct for frequency, timing, and/or phase errors (as in optional step 306), the procedure shown in FIG. 3 arrives at step 308 with a “corrected” symbol stream. In step 308, the corrected symbol stream is analyzed to determine values of cumulant-based measures associated with the symbol stream.

Different cumulants are statistically correlated, but have a degree of mutual independence. As such, by using multiple cumulants in combination, classification performance improvements can be obtained over techniques in which a single value of a cumulant-based measure is calculated and used for classification of a symbol stream.

Various higher-order cumulants (e.g., fourth-order, sixth-order, eighth-order, and even higher order) can be calculated and used in various combinations to classify the modulation type for the symbol stream in step 308. By using a hierarchical set of decision steps (e.g., organized in a decision tree), each of which tests against a range of values for a cumulant-based measure associated with a symbol stream, overlapping ranges of particular cumulant-based measures can be used for group classification, e.g., mQAM versus mPSK, since at least some of the candidate modulation types are characterized in terms of multiple different cumulant-based measures.

The corrected symbol stream x[n] in step 308 can be represented (with noise) as:

$$x [ n ] = A {e}^{j ( 2 π {f}_{0} nT + φ )} s [ n ] + η [ n ] \qquad [ 1 ]$$

where A is a unknown scalar amplitude, f₀ is a residual carrier frequency, T is the symbol period, φ is a constant phase offset, and n[n] is a complex-valued additive white Gaussian noise process. In a time-dependent representation:

$$x ( t ) = a {e}^{j ( 2 π {f}_{0} t + φ )} {\sum }_{k} {s}_{k} p ( t - k T - {t}_{0} ) - η ( t ) \qquad [ 2 ]$$

where p(t) is a pulse function.

A stationary random process can be characterized by its moments and/or cumulants. The mixed moments of a complex-valued, stationary random process x[n] are defined as

$${M}_{p q} = 𝔼 \{ {x [ n ]}^{( p - q )} {( {x}^{*} [ n ] )}^{q} \} \qquad [ 3 ]$$

where [symbol] is the expectation operator and * is the complex conjugate operator. Equation (3) can be approximated as

$${\hat{M}}_{p q} = \frac{1}{N} {\sum }_{n = 0}^{N - 1} {x [ n ]}^{( p - q )} {( {x}^{*} [ n ] )}^{q} \qquad [ 4 ]$$

Arbitrary mixed cumulants are generated by defining a set of random variables which consist of either x[n] or x*[n] as

$$S = \{ x [ n ] , … , x [ n ] , {x}^{*} [ n ] , … , {x}^{*} [ n ] \} \qquad [ 5 ]$$

where the π terms are p-q terms and the x* terms are q terms. The cumulant is generated from the moment-to-cumulant function:

$${C}_{p q} ( S ) = {\sum }_{π} {( - 1 )}^{\vert π \vert - 1} ( \vert π \vert - 1 ) ! {\prod }_{B ϵ π} 𝔼 [ {\prod }_{i ϵ B} {S}_{i} ] \qquad [ 6 ]$$

where π steps through all partitions of S, the number of sets in π is equal to |π|, and B is a set within a particular partition π. Sᵢ is the i-th element in S. For example, if S={x, x, x*, x*}, then the possible partitions would be:

$$\{ ( x x {x}^{*} {x}^{*} ) \}$$

$$\{ ( x ) , ( {xx}^{*} {x}^{*} ) \} , \{ ( x x {x}^{*} ) , ( {x}^{*} ) \}$$

$$\{ ( xx ) , ( {xx}^{*} ) \} , \{ ( x {x}^{*} ) , ( {xx}^{*} ) \} , \{ ( x {x}^{*} ) , ( {xx}^{*} ) \}$$

$$\{ ( x ) \} , \{ ( x ) \} , \{ ( {x}^{*} ) \} , \{ ( {x}^{*} ) \}$$

Assuming that x[n] has a zero mean (i.e., [symbol] {x}=0), then from Equation (6) we have

$${C}_{42} = {( - 1 )}^{( 1 - 1 )} ( 1 - 1 ) ! 𝔼 \{ {xxx}^{*} {x}^{*} \} + {( - 1 )}^{( 2 - 1 )} ( 2 - 1 ) ! [ 𝔼 \{ xx \} 𝔼 \{ {x}^{*} {x}^{*} \} + 𝔼 \{ {xx}^{*} \} 𝔼 \{ {xx}^{*} \} + 𝔼 \{ x {x}^{*} \} 𝔼 \{ x {x}^{*} \} ] \qquad [ 7 ]$$

Equation (7) simplifies to

$${C}_{42} = {M}_{42} - {\vert {M}_{20} \vert}^{2} - 2 {M}_{21}^{2} \qquad [ 8 ]$$

which can be expressed in terms of x[n] as

$${C}_{42} = \frac{1}{N} {\sum }_{k = 1}^{N} {\vert x [ k ] \vert}^{4} - {\vert \frac{1}{N} {\sum }_{k = 1}^{N} {x}^{2} [ k ] \vert}^{2} - 2 {( \frac{1}{N} {\sum }_{k = 1}^{N} \vert x [ k ] \vert )}^{2} \qquad [ 9 ]$$

As described above, multivariate cumulants are used to identify different modulation types in the techniques described herein. Examples of these multivariate cumulants can be calculated as follows:

$$c u m ( x x ) = {C}_{20} = {M}_{20} \qquad [ 10 ]$$

$$cum ( x {x}^{*} ) = {C}_{21} = {M}_{21} \qquad [ 11 ]$$

$$cum ( x x x x ) = {C}_{40} = {M}_{40} - 3 {M}_{20}^{2} \qquad [ 12 ]$$

$$cum ( x x x {x}^{*} ) = {C}_{41} = {M}_{41} - 3 {M}_{20} {M}_{21} \qquad [ 13 ]$$

$$cum ( x x {x}^{*} {x}^{*} ) = {C}_{42} = {M}_{42} - {\vert {M}_{20} \vert}^{2} - 2 {M}_{21}^{2} \qquad [ 14 ]$$

$$cum ( xxxxxx ) = {C}_{60} = {M}_{60} - 15 {M}_{20} {M}_{40} + 30 {M}_{20}^{3} \qquad [ 15 ]$$

$$cum ( x x x x x {x}^{*} ) = {C}_{61} = {M}_{61} - 5 {M}_{21} {M}_{40} - 10 {M}_{20} {M}_{41} + 30 {M}_{20}^{2} {M}_{21} \qquad [ 16 ]$$

$$cum ( x x x x {x}^{*} {x}^{*} ) = {C}_{62} = {M}_{62} - 6 {M}_{20} {M}_{42} - 8 {M}_{21} {M}_{41} - {M}_{22} {M}_{40} + 6 {M}_{20}^{2} {M}_{22} + 24 {M}_{21}^{2} {M}_{20} \qquad [ 17 ]$$

$$cum ( x x x {x}^{*} {x}^{*} {x}^{*} ) = {C}_{63} = {M}_{63} - 9 {M}_{21} {M}_{42} + 12 {M}_{21}^{3} - 3 {M}_{20} {M}_{43} - 3 {M}_{22} {M}_{41} + 18 {M}_{20} {M}_{21} {M}_{22} \qquad [ 18 ]$$

$$cum ( xxxxxxxx ) = {C}_{80} = {M}_{80} - 28 {M}_{20} {M}_{60} - 56 {M}_{30} {M}_{50} - 35 {M}_{40}^{2} + 420 {M}_{40} {M}_{20}^{2} + 560 {M}_{30}^{2} {M}_{20} - 630 {M}_{20}^{4} \qquad [ 19 ]$$

In general, the classification strategy described herein involves using combinations of different cumulant values to distinguish among multiple different modulation types for an incoming symbol stream. By using a sufficient number of combinations of cumulant values, each member of a set of different possible modulation types can be distinguished from the other members of a set on the basis of the different combinations of cumulant values. As such, the particular modulation type associated with a particular symbol stream can be identified.

It should be understood that this methodology can be extended to any number of different modulation types and any set of candidate modulation types. In general, the only constraint for positive identification of a single modulation type is that among the different combinations of cumulant values used, each different candidate modulation type is uniquely identified by a particular set of combinations of cumulant values. When this condition holds, a hierarchical decision tree or truth table can be constructed that allows each different candidate modulation type to be identified.

The methods described herein can generally be applied for any number P of candidate modulation types. For example, P can be 2 or more (e.g., 4 or more, 8 or more, 12 or more, 16 or more, 20 or more, or even more). As the number of candidate modulation types increases, the number of different cumulant values that are computed also increases to ensure than each candidate modulation type can be uniquely identified.

It should also be understood that this methodology can be combined with other techniques and/or information for identifying modulation types. For example, in some embodiments, the techniques described herein can be used to analyze an incoming symbol stream for modulation type using a candidate field of P different candidate modulation types, and to determine that the modulation type is one of Q different candidate modulation types, where Q<P. In this instance, the difference between P and Q can be 1 or more (e.g., 2 or more, 3 or more, 4 or more, 5 or more, 6 or more, 7 or more, 8 or more, or even more). The reduced number of different candidate modulation types, Q, can be, for example, 1 or more (e.g., 2 or more, 3 or more, 4 or more, 5 or more, 6 or more, or even more).

In some implementations, cumulant values are used to “narrow the field” of possible candidate modulation types for an incoming symbol stream, but not necessarily to always uniquely identify the modulation type. In such circumstances, other techniques and/or information can be used to distinguish among the members of the narrowed set of candidate modulation types. By way of example only, for an incoming symbol stream that may be encoded according to one of 10 different modulation types, the techniques described herein can be used to effectively discount 8 of the 10 different candidate modulation types, resulting in a determination that the symbol stream is encoded according to one of two possible remaining candidate modulation types. These two remaining candidate modulation types can be distinguished, if desired, using additional information (for example, a priori information that one of the two remaining candidate modulation types was not used to encode the symbol stream), or by using another analytical method for distinguishing among the remaining candidate modulation types.

A variety of other analytical methods can be used to distinguish among the remaining candidate modulation types if cumulant values alone do not arrive at a unique determination of modulation type. In some embodiments, for example, linear classification schemes can be used. Linear classification schemes work by projecting data into a feature space using a linear mapping and then comparing the result to a centroid for each class. If the data is linearly separable, these schemes work well to find the best projection matrix. As an example of a linear classification scheme, Principal Component Analysis (PCA) can be used in certain embodiments to distinguish among the remaining candidate modulation types. PCA seeks the best representation of the data in a least-squares sense. It does this by decomposing the data covariance matrix into its eigenvectors and choosing the most significant of them to form a projection matrix. The columns of the projection matrix define the feature space into which the statistical profiles will be projected. The eigenvectors corresponding to the top k eigenvalues form the projection matrix. The centroids for each class are then calculated.

To perform a classification, the projection of a test profile t into the feature space t′ is calculated, and the centroid having the smallest Euclidean distance to the point t′ is selected as the modulation type for the test profile. This method can be fairly computationally expensive compared to the cumulant-based methods described above because typically the singular value decomposition (SVD) is used to obtain the eigenvectors and associated eigenvalues.

As will be appreciated from the foregoing discussion, the number of different cumulant values and combinations thereof that can be used in the techniques described herein is not limited, and the particular combinations of different cumulant values that are used in a given implementation will depend upon the set of candidate modulation types. To simplify the discussion, an example is discussed below in which 7 different candidate modulation types are uniquely distinguished for an incoming symbol stream. However, it should be understood that this is merely one example, and the number of candidate modulation types may be smaller or larger, and the various combinations of cumulant values may be different from those described in connection with the example. Further, as discussed above, it should be understood that in some implementations, not all candidate modulation types may be uniquely identified; in certain classification schemes, the set of possible candidate modulation types is reduced not to a single member, but simply to a smaller number of members. In these circumstances, if desired, the reduced set of candidate modulation types may be distinguished using other techniques and/or information.

By way of illustration only, consider an example in which an incoming symbol stream is encoded according one of 7 different modulation types: BPSK, QPSK, 8PSK, 8QAM, 16QAM, 16APSK, and 32APSK. These different candidate modulation types have different theoretical values for different combinations of the cumulant values shown in Equations (10)-(19). The theoretical values for a selection of different combinations of cumulant values is shown in Table 1.

TABLE 1

| Modulation Type | \|C₂₀\| | \|C₂₁\| | \|C₄₀\| | \|C₄₁\| | \|C₄₂\| | $\frac{\vert {C}_{40} \vert}{\vert {C}_{42} \vert}$ | $\frac{\vert {C}_{41} \vert}{\vert {C}_{42} \vert}$ | \|C₆₃\| | $\frac{{\vert {C}_{63} \vert}^{2}}{{\vert {C}_{42} \vert}^{3}}$ | \|C₈₀\| |
|---|---|---|---|---|---|---|---|---|---|---|
| BPSK | 1 | 1 | 2 | 2 | 2 | 1 | 1 | 16 | 32 | 272 |
| QPSK | 0 | 1 | 1 | 0 | 1 | 1 | 0 | 4 | 16 | 34 |
| 8PSK | 0 | 1 | 0 | 0 | 1 | 0 | 0 | 4 | 16 | 1 |
| 8QAM | 0 | 4.7 | 26 | 0.1 | 15 | 1.7 | 0 | 2 | 13.5 | 22,000 |
| 16QAM | 0 | 1 | 0.67 | 0 | 0.67 | 1 | 0 | 2.1 | 13.7 | 13.98 |
| 16APSK | 0 | 0.77 | 0 | 0 | 0.44 | 0 | 0 | 2.3 | 13 | 14 |
| 32APSK | 0 | 0.6 | 0 | 0 | 0.22 | 0 | 0 | 1.45 | 10.8 | 0 |

To distinguish among the 7 different candidate modulation types shown in Table 1, a 10-element feature vector u[m] (m=0 . . . 9) can be constructed, with the following elements defined for the feature vector:

$$u [ 0 ] = \vert {C}_{20} \vert \qquad [ 20 ]$$

$$u [ 1 ] = \vert {C}_{21} \vert$$

$$u [ 2 ] = \vert {C}_{40} \vert$$

$$u [ 3 ] = \vert {C}_{41} \vert$$

$$u [ 4 ] = \vert {C}_{42} \vert$$

$$u [ 5 ] = \frac{\vert {C}_{40} \vert}{\vert {C}_{42} \vert}$$

$$u [ 6 ] = \frac{\vert {C}_{41} \vert}{\vert {C}_{42} \vert}$$

$$u [ 7 ] = \frac{\vert {C}_{63} \vert}{{\vert {C}_{21} \vert}^{3}}$$

$$u [ 8 ] = \frac{{\vert {C}_{63} \vert}^{2}}{{\vert {C}_{42} \vert}^{3}}$$

$$u [ 9 ] = \vert {C}_{80} \vert$$

Values for the feature vector elements u[m] shown in Equation (20) can be determined from estimates for each of the cumulants C₂₀, C₂₁, C₄₀, C₄₁, C₄₂, and C₆₃. For the corrected symbol stream represented by x[n], estimates can be computed for the cumulants according to the following:

$${\hat{C}}_{20} = \frac{1}{N} {\sum }_{k = 0}^{N - 1} {x [ k ]}^{2} \qquad [ 21 ]$$

$${\hat{C}}_{21} = \frac{1}{N} {\sum }_{k = 0}^{N - 1} {\vert x [ k ] \vert}^{2} \qquad [ 22 ]$$

$${\hat{C}}_{40} = \frac{1}{N} {\sum }_{k = 1}^{N} {x}^{4} [ k ] - 3 {\hat{C}}_{20} \qquad [ 23 ]$$

$${\hat{C}}_{41} = \frac{1}{N} {\sum }_{k = 1}^{N} {x}^{3} [ k ] {x}^{*} [ k ] - 3 {\hat{C}}_{20} {\hat{C}}_{21} \qquad [ 24 ]$$

$${\hat{C}}_{42} = \frac{1}{N} {\sum }_{k = 1}^{N} \vert {x}^{4} [ k ] \vert - {\vert \frac{1}{N} {\sum }_{k = 1}^{N} {x}^{2} [ k ] \vert}^{2} - 2 {( \frac{1}{N} {\sum }_{k = 1}^{N} \vert {x}^{2} [ k ] \vert )}^{2} \qquad [ 25 ]$$

$${\hat{C}}_{63} = \frac{1}{N} {\sum }_{k = 1}^{N} {\vert x [ k ] \vert}^{6} - 9 ( \frac{1}{N} {\sum }_{k = 1}^{N} {\vert x [ k ] \vert}^{4} ) ( \frac{1}{N} {\sum }_{k = 1}^{N} {\vert x [ k ] \vert}^{2} ) + 12 {\vert \frac{1}{N} {\sum }_{k = 1}^{N} {x}^{2} [ k ] \vert}^{2} ( \frac{1}{N} {\sum }_{k = 1}^{N} {\vert x [ k ] \vert}^{2} ) + 12 {( \frac{1}{N} {\sum }_{k = 1}^{N} {\vert x [ k ] \vert}^{2} )}^{3} \qquad [ 26 ]$$

For the current example, hierarchical discrimination among the 7 different candidate modulation types is based on both values of individual cumulants, and combinations of the cumulant values as illustrated in Equation (20). However, it should be appreciated that the particular cumulants and combinations thereof that are used to discriminate among the 7 candidate modulation types are selected based on the values of the cumulants and combinations for the particular set of candidate modulations in this example.

More generally, a different set of cumulants and combinations of cumulants can be used to discriminate among the candidate modulations of the example, and to discriminate among a different set of candidate modulations. For example, any of the cumulants described herein, as well as any other cumulants, and combinations of any of these, can be used to construct a set of measures (i.e., the elements of the feature vector described above) for use in distinguishing among a set of candidate modulations for a symbol stream.

The number of different cumulants and combinations of cumulants-which is, in effect, the number of elements in the feature vector—can generally be selected as desired to allow for a desired extent of discrimination among different modulation types. As described above, in some embodiments, the techniques described herein achieve a singular identification of modulation type such that a single modulation type for an incoming symbol stream is identified. In certain embodiments, the techniques described herein reduce the number of candidate modulation types for an incoming signal by eliminating certain modulation types from a candidate pool, and then other techniques and/or information are used to achieve a singular identification from a narrowed pool of candidate modulations. Under either implementation, the number of different cumulant values and combinations of cumulant values can be 2 or more (e.g., 3 or more, 4 or more, 5 or more, 6 or more, 8 or more, 10 or more, 12 or more, 15 or more, 20 or more, or even more).

In certain embodiments, for a pool of M candidate modulations, the number of different cumulant values and combinations of cumulant values E—which is, in effect, the number of different elements of the feature vector described above, is less than M. The difference between M and E can be 1 or more (e.g., 2 or more, 3 or more, 4 or more, 5 or more, 7 or more, or even more).

In some embodiments, such as the example above, E can be equal to or greater than M. For example, E can be larger than M by 1 or more (e.g., 2 or more, 3 or more, 4 or more, 5 or more, 6 or more, 8 or more, 10 or more, 15 or more, or even more).

Returning to FIG. 3, after a set of cumulant-based measures has been identified for the set of candidate modulation types in step 308, ranges for the cumulant-based measures are determined in step 310. The use of ranges effectively establishes a Boolean truth table for each modulation type with respect to each of the cumulant-based measures. Consider for example a modulation type “ABC” and a set of cumulant-based measures m1, m2, . . . , mt. In step 310, ranges for each of m1, m2, . . . , mt for modulation type ABC are defined; in other words, the ranges for m1, m2, . . . , mt represent the expected ranges of values for each modulation type exhibited by a signal encoded with modulation type ABC. This process is repeated for each candidate modulation type.

In this way, the expected range of values of each cumulant-based measure for each candidate modulation type effectively establishes a truth table for that modulation type. Classification of incoming signal's modulation type then involves determining values of each of the cumulant-based measures previously identified, and comparing to the expected ranges of the measures for each candidate modulation.

Expected ranges for each of the cumulant-based measures will depend on a number of factors that influence noise in the detected incoming symbol stream. The theoretical values shown in Table 1 represent circumstances in which the incoming symbol stream is detected at very high signal-to-noise ratio, with no carrier frequency offset and ideal symbol timing synchronization. Such assumptions rarely hold for real-world signals. Instead, real-world signals with lower signal-to-noise ratios have associated expected ranges for each cumulant-based measure for each candidate modulation type that allow for greater flexibility in identifying whether the calculated value of a given cumulant-based measure is consistent with, or inconsistent with, each different candidate modulation type.

Expected ranges for each of the cumulant-based measures can be determined in a variety of ways. For example, in some embodiments, expected ranges are determined using Monte Carlo simulations for signals modulated according to each of the different candidate modulation types. In addition to providing expected ranges for the different modulation types, such simulations allow a hierarchical decision tree to be constructed that, in principle, allows for unique identification of some or all of the different candidate modulation types.

It should be noted that as the signal-to-noise ratio decreases for the sampled symbol stream, the hierarchical decision tree may be modified in circumstances where ranges for the individual cumulant values for different modulation types begin to overlap. Such overlap may make it more difficult to discriminate among different modulation types based on the cumulant values. To accommodate increasing noise, additional branches of the hierarchical tree may be used to filter down further to distinguish among modulation types for a noisier signal. Further, as described above, additional classification methods can be used where the cumulant-based methods described herein do not arrive at a unique determination of modulation type.

Returning to FIG. 3, after expected ranges for each of the cumulant-based measures have been determined for each candidate modulation type, in step 312 the modulation type associated with the incoming symbol stream is identified. Effectively, step 312 involves classifying the modulation type of the incoming signal based on the computed cumulant-based measures and the expected ranges (i.e., truth tables) of the measures for each of the candidate modulation types.

Identification of the modulation type can be performed in a variety of ways. In some embodiments, the identification involves a hierarchical decision tree and a set of binary decision steps that are used to identify the candidate modulation type that is consistent with each of the computed cumulant-based measures for the incoming symbol stream.

To better understand the nature of this hierarchical decision-making process, consider a hypothetical example in which there are five candidate modulation types B₁, B₂, . . . , B₅ for an incoming signal. Six different cumulant-based measures m1, m2, . . . , m6 are used for identification of the modulation type of the incoming signal. Successive steps of the hierarchical identification process are shown in Table 2. In each step, a different one of the computed cumulant-based measures is compared against the expected ranges of that measure for each of the different candidate modulation types. The expected ranges for each cumulant-based measure are shown in the table, and the computed value for the cumulant-based measure is shown in the column header. All values in the table are representative only, and provided only for illustrative purposes.

TABLE 2

| Candidate | Step 1 | Step 2 | Step 3 | Step 4 | Step 5 | Step 6 |
|---|---|---|---|---|---|---|
| Modulation | (m1 = 0.8) | (m2 = 14) | (m3 = 144) | (m4 = 70) | (m5 = 320) | (m6 = 1.6) |
| B₁ | 0.6-0.9 | 10-30 | 100-200 | 100-200 | 500-1400 | 0.5-5.5 |
| B₂ | 0.6-0.9 | 10-30 | 130-170 | 50-150 | 500-1400 | 12-22 |
| B₃ | 1.5-2.0 | 5-25 | 1-500 | 30-50 | 100-150 | 0.1-20 |
| B₄ | 0.5-3.5 | 0-100 | 0.1-1000 | 10-100 | 100-1000 | 1.0-4.5 |
| B₅ | 0.1-2.0 | 0-25 | 600-800 | 1500-3000 | 100-5000 | 0.1-20 |

As is evident from Table 2, each of the candidate modulation types can be uniquely identified based on computed values of cumulant-based measures m1 . . . m6. In step 1 of the hierarchical decision sequence, the computed value of cumulant measure m1 is compared with the expected ranges of m1 for each of the candidate modulation types. For modulation type B₃, the computed value of m1 is outside the expected range, and therefore it can be concluded that B₃ is not the modulation type of the incoming signal. The other modulation types have expected ranges for m1 that are consistent with the computed value of m1 from the incoming symbol stream, and therefore remain possible candidate modulation types.

In step 2, the computed value of m2 is compared with the expected ranges for m2 for the candidate modulation types. The value of m2 is within all of the expected ranges, and so no candidate modulation types can be excluded in step 2. In steps 3-6, similar comparisons are performed with computed values of cumulant measures m3, m4, m5, and m6, respectively. Modulation type B₅ is excluded as a candidate in step 3, while modulation type B₁ is excluded as a modulation type in step 4. In step 5, modulation type B₃ fails the comparison test against the computed value of m5, but B₃ was already excluded in step 1. In step 6, the only two non-excluded candidate modulations, B₂ and B₄, are distinguished, as B₂ fails the comparison test with m6. Following the 6-step hierarchical test procedure, candidate modulation B₄ is identified as the modulation type of the incoming signal.

It should be noted that, depending upon the set of candidate modulation types and the set of cumulant-based measures that are used to perform the hierarchical decision sequence, it is possible that in some steps (such as step 2 above, for example), no candidate modulation types fail the comparison test and are excluded. It is also possible that in some steps (such as step 4, for example), multiple candidate modulation types fail the comparison test and are excluded.

More generally, the number of steps required for “convergence”—that is, the number of hierarchical decision steps until a determination of the incoming signal's modulation type (or until the pool of candidate modulation types is sufficiently narrowed to a pre-determined number of candidates)—depends on the number of candidate modulation types, their associated expected ranges of cumulant-based measures, and the set of cumulant-based measures that are selected for evaluation. The number of steps can be less than, equal to, or greater than the number of candidate modulation types in the evaluation pool.

In the representative example shown in Table 2, certain modulation types (B₁, B₃, and B₅) were excluded prior to the final step 6 that distinguished between B₂ and B₄. In some embodiments, modulation types that are excluded in an earlier decision step can be eliminated from further consideration (and the comparisons to cumulant-based measures for that modulation type not performed) after the step in which they fail the comparison test for the first time. In the example above, modulation type B₃ can be excluded in step 1, and comparison tests between computed values of m2 . . . m6 and expected ranges for these cumulant measures for B₃ can be omitted in steps 2 through 6. This saves computational cycles and may increase the rate at which the hierarchical decision sequence converges. In certain embodiments, however, comparisons relating to modulation type B₃ (and the other later-excluded modulation types) are still performed to provide additional information in the event that the hierarchical decision sequence does not yield identification of a singular candidate modulation type.

As is evident from the example above, in some embodiments, it can be possible to reduce the convergence time by selecting the order in which comparisons to specific cumulant-based measures are performed. For a particular cumulant-based measure, it is sometimes observed that certain types of modulations (such as mPSK modulations) have significantly different expected ranges than other types of modulations (such as mQAM modulations). Thus, a pool of candidate modulations consisting of a subset of mPSK and mQAM modulation types can be separated into two different subclasses, one of which has members that are excluded and the other which contains members that remain candidates, via comparison to a single cumulant-based measure. The remaining candidate modulation types within the second subclass can then be distinguished via further comparisons to different cumulant-based measures as described above. By performing this initial comparison relatively early (or even first) in the decision sequence, it can be possible to eliminate multiple modulation types from further consideration relatively early in the procedure.

To illustrate this point, consider again the example shown in Table 1 above, in which 7 different candidate modulation types are considered for an incoming symbol stream. It may be possible to first distinguish between mPSK and mQAM subclasses of modulations by performing a comparison to the value of the Ĉ₆₃ cumulant, and then distinguish among BPSK, QPSK, and 8PSK candidate modulations based on a comparison to the value of the Ĉ₈₀ cumulant. Similarly, it may also be possible to distinguish among candidate modulations 8QAM, 16QAM, 16APSK, and 32 APSK based on a comparison to the value of the Ĉ₈₀ cumulant.

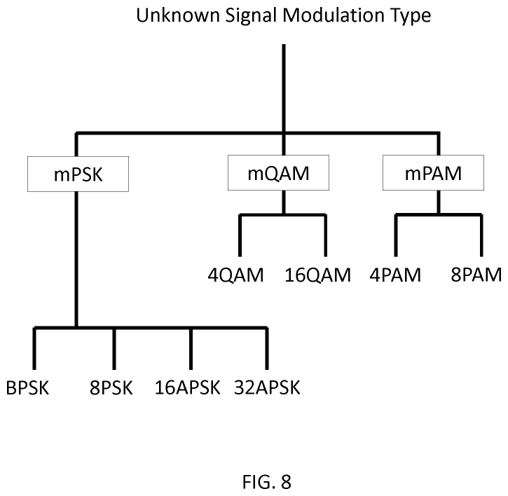

An example hierarchical decision tree for mPSK, mQAM, and mPAM subclasses of modulation types is shown in FIG. 8. This hierarchical approach attempts to first classify the unknown modulation type using “macro” characteristics into one of the three subclasses, and then to refine membership into a further subclass using “micro” characteristics. For the decision tree shown in FIG. 8, the different candidate modulation types considered can be naturally divided into four subclasses: binary PSK (BPSK), PAM (real-valued), PSK (constant-modulus), and QAM (general complex-valued). Each modulation type can be distinguished based on a different combination of HOC values (and combinations of HOC values), which form a set of features that can be used to uniquely identify the modulation type.

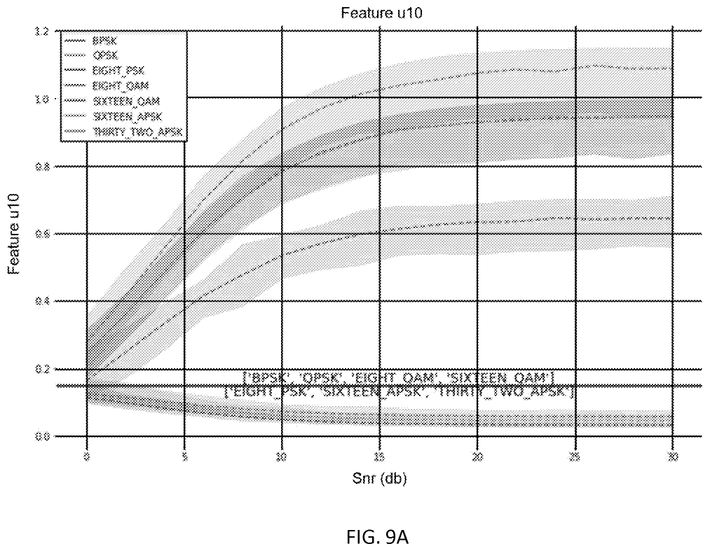

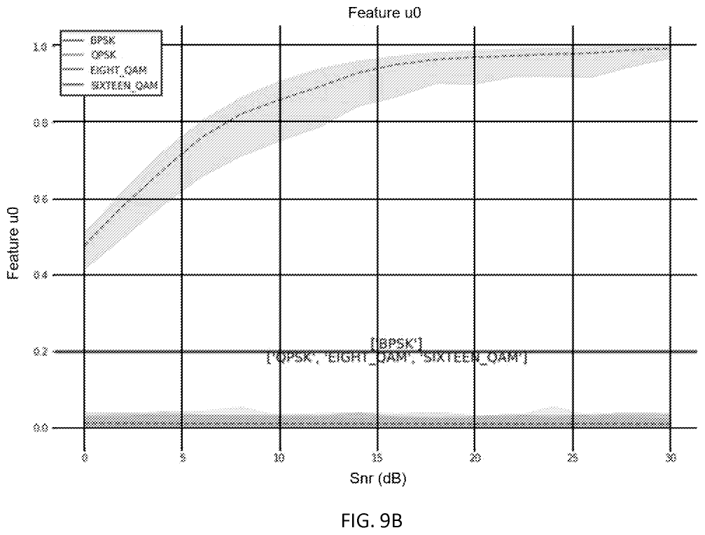

FIG. 9A is a graph showing values of a particular cumulant-based feature u10 for different modulation types. It is notable that the different modulation types are distinguishable over a broad range of SNR, except for BPSK and QPSK. FIG. 9B is a graph showing values of another cumulant-based feature u0 for different modulation types. Although not distinguishable on the basis of u10, it is observed in FIG. 9B that BPSK and QPSK modulations are readily distinguished based on the value of feature u0. Values of various combinations of HOC-based features can be used to follow unique routes through different branches of the hierarchical decision tree shown in FIG. 8, uniquely identifying each of the different candidate modulation types.

As is evident from the representative expected ranges for cumulant measures shown in Table 2 for each of the candidate modulation types, to ensure that convergence to a singular identification of modulation type occurs, the expected ranges for the different candidate modulation types should be sufficiently different that candidate modulation types can be excluded (i.e., fail the comparison test) at a sufficient number of steps in the hierarchical sequence. One way to achieve convergence is to select a set of cumulant-based measures such that for each candidate modulation type, the expected range for at least one member of the set of cumulant-based measures falls outside the expected range for that cumulant-based measure for all other candidate modulation types. In effect, this condition establishes a binary pass-fail test based on that cumulant-based measure in which the associated candidate modulation type is either excluded when all other candidate modulation types pass the test, or remains included when all other candidate modulation types fail the test. By ensuring that each candidate modulation type is subject to at least one similar comparison test, convergence to a singular identification of modulation type can be ensured in some circumstances.

However, convergence to a singular identification of modulation type does not require the above condition. Instead, it has been observed that convergence can be successfully achieved even when no single cumulant-based measure has an expected range for one candidate modulation type that is fully exclusive of the expected ranges for the other candidate modulation types. To the contrary, it is the combination of expected ranges for each candidate modulation type that allows the candidate modulation type to be distinguished from other candidate modulation types. Only when two candidate modulation types have a set of expected ranges that are all sufficiently close to one another does distinguishing between the candidate modulation types become more challenging.

In some circumstances, the decision sequence does not result in a singular identification of modulation type. In this event, a variety of actions can be taken. In some embodiments, for example, the procedure may terminate with the conclusion that either the modulation type for the incoming signal is unknown within the set of candidate modulation types, or the modulation type is a mixture of different types that requires additional processing to separate.

In certain embodiments, the procedure may identify the “most likely” candidate modulation type as the modulation associated with the incoming signal. The most likely candidate modulation type can be determined in a variety of different ways, for example using linear projection classification methods (such as projection to a centroid defined for each candidate class and selecting the class with the minimum distance as “most likely”, as described above).

Returning to FIG. 3, after the signal modulation type has been identified in step 312, a signal decoder is configured in step 314 for the identified modulation type and the incoming symbol stream, after being corrected as described above in connection with step 304, is then decoded based on the identified modulation type to extract information from the symbol stream.

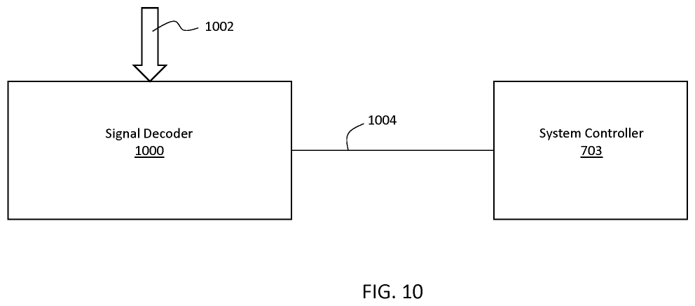

FIG. 10 is a schematic diagram showing an example signal decoder 1000 connected to a system controller 703. As will be discussed later, software instructions that implement the various steps described herein operate in system controller 703. For example, system controller 703 can determine the signal modulation type for an incoming symbol stream as discussed above in connection with FIG. 3.

After determining the signal modulation type, system controller 703 can transmit control instructions to signal decoder 1000 to configure signal decoder 1000 specifically to decode the incoming symbol stream. In general, signal decoder includes analog and/or digital components that may include, but are not limited to, filters, gates, diodes, and other logic and signal processing elements. These elements cooperate to demodulate the incoming symbol stream by implementing a particular decoding scheme.

In some embodiments, signal decoder 1000 includes a plurality of different decoding modules, each configured to implement a particular decoding scheme. Control signals transmitted via control line 1004 from system controller 703 route the incoming symbol stream 1002 to a particular decoding module that corresponds to the identified modulation type of the symbol stream. The decoding module to which the symbol stream is routed is then used exclusively to decode the symbol stream.

In certain embodiments, signal decoder 1000 contains common components that can be configured to implement multiple different decoding schemes. Control signals transmitted from system controller 703 configure the components of signal decoder 1000 according to the identified modulation type of the symbol stream. When the incoming symbol stream 1002 is routed through signal decoder 1000 by system controller 703, the symbol stream is decoded based on the decoding configuration implemented by the control signals transmitted by system controller 703.

Either implementation described above yields a system in which signal decoder 1000 is particularly configured by system controller 703 based on the identified modulation type to decode an incoming symbol stream. That is, the steps performed by system controller 703 yield a specialized signal decoder that is configured without any a priori knowledge of the incoming symbol stream, and which nonetheless is matched to the signal modulation type of the symbol stream so that the stream can be accurately decoded, preserving and extracting as much information as possible from the stream.

Returning to FIG. 3, and following decoding of the incoming symbol stream, the procedure shown in FIG. 3 ends at step 316.

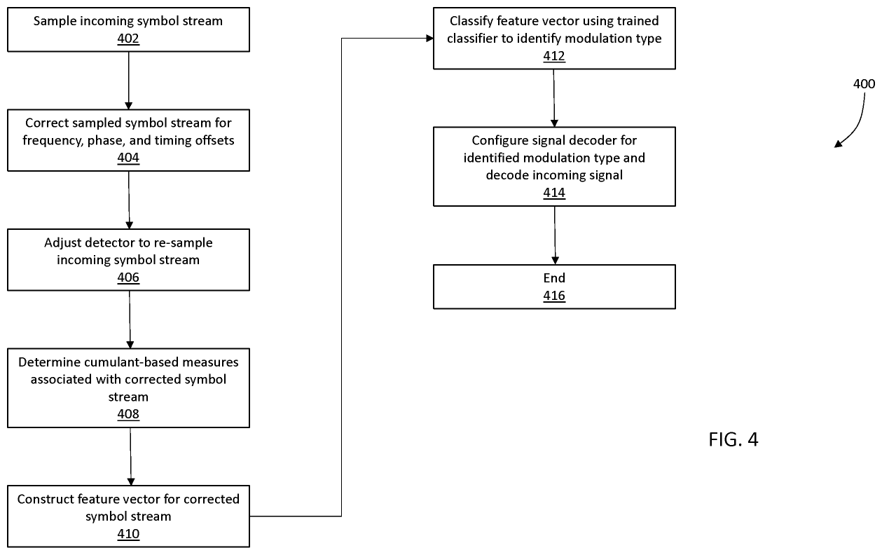

The procedure described above in connected with steps 310 and 312 of FIG. 3 involves a hierarchical sequence of decision steps that are used to identify a candidate modulation type for an incoming signal based on a set of cumulant-based measures computed for the signal. For purposes of identifying the signal's modulation type, other methods based on a set of cumulant-based measures can also be used. FIG. 4 is a flow chart 400 showing a set of example steps for identifying the modulation type of an incoming signal that does not involve a hierarchical decision sequence. Steps 402, 404, 406, and 408 are similar to corresponding steps 302, 304, 306, and 308 of FIG. 3 and will not be discussed further.

In step 410 of flow chart 400, after the set of cumulant-based measures associated with the corrected signal stream are determined, a feature vector for the signal is constructed as described above. The elements of the feature vector correspond to the set of cumulant-based measures. The number and types of cumulant-based measures are selected based on the criteria discussed above. The feature vector generally contains a suitable number of elements such that identification of the modulation type of the incoming symbol stream can be determined with a high rate of convergence.

Next, in step 412, the feature vector is classified in a blind classification process to identify the modulation type associated with the incoming symbol stream. This step typically involves submitting the feature vector to a trained neural network or other machine learning-based trained classifier that takes as input the elements of the feature vector and generates as output, when convergence is achieved, the most likely modulation type for the incoming symbol stream. It is notable that is this procedure, the elements of the feature vector are values of cumulant-based measures, and so the classification performed by the classifier is based on a set of higher order cumulants.

In addition to values of cumulant-based measures, the feature vector can also include elements that encompass other types of information useful to perform the classification. Other types of information/elements can include, for example, information that may be specific to certain types of modulations but not others, and/or a priori information about signals that are modulated according to certain modulation types.

Following identification of the modulation type of the incoming signal in step 412, the procedure shown in FIG. 4 moves to steps 414 and 416 which are similar to corresponding steps 314 and 316 in FIG. 3 and are not discussed further.

Trained machine-based classifiers can also be used in circumstances where the hierarchical decision methodology described in connection with FIG. 3 cannot uniquely identify a single modulation type associated with a sampled signal (i.e., two or more candidate modulation types still remain as possibilities), or when the methodology eliminates all possible candidate modulation types. Such situations can arise, for example, when the sampled symbol stream is particularly noisy, or when the signal is relatively weak. Both circumstances yield a sampled symbol stream with low SNR, which can make discrimination based on cumulant values alone more difficult.

The performance of the procedures described herein can be understood in terms of confusion matrices. In a confusion matrix, also known as an error matrix (or a matching matrix in an unsupervised classification scheme), each row of the matrix represents instances in an actual class while each column represents instances in a predicted class (or vice versa). That is, it is a special type of contingency table with two dimensions (“actual” and “predicted”) and identical sets of classes (i.e., modulation types) in both dimensions.

Monte Carlo simulations were performed for an incoming signal with a signal-to-noise (SNR) of 0 dB (Table 3), 5 dB (Table 4) and 15 dB (Table 5), showing performance of the hierarchical decision sequence described above for each incoming signal. The set of cumulant-based measures selected were those shown in Table 1 for the 5 dB and 15 dB signals, while a different set of cumulant-based measures were used for the 0 dB signal. The set of candidate modulations were also those shown in Table 1.

TABLE 3

| Modulation | BPSK | QPSK | 8PSK | 8QAM | 16QAM | 16APSK | 32APSK |
|---|---|---|---|---|---|---|---|
| BPSK | 100 | | | | | | |
| QPSK | | 98.6 | 1.4 | | | | |
| 8PSK | | | 99 | 1 | | | |
| 8QAM | | | | 100 | | | |
| 16QAM | | 12.4 | | | 87.6 | | |
| 16APSK | | | | | 4.5 | 95.5 | |
| 32APSK | | | | | | | 100 |

TABLE 4

| Modulation | BPSK | QPSK | 8PSK | 8QAM | 16QAM | 16APSK | 32APSK |
|---|---|---|---|---|---|---|---|
| BPSK | 99.75 | 0.25 | | | | | |
| QPSK | | 98.5 | | | 1.5 | | |
| 8PSK | | | 99.25 | | | | |
| 8QAM | | 0.25 | | 99.75 | | | |
| 16QAM | | 2 | | | 98 | | |
| 16APSK | | | | 0.75 | | 99.25 | |
| 32APSK | | | | | | | 100 |

TABLE 5

| Modulation | BPSK | QPSK | 8PSK | 8QAM | 16QAM | 16APSK | 32APSK |
|---|---|---|---|---|---|---|---|
| BPSK | 100 | | | | | | |
| QPSK | | 99 | | | 1 | | |
| 8PSK | | | 100 | | | | |
| 8QAM | | | | 100 | | | |
| 16QAM | | | | | 100 | | |
| 16APSK | | | | | | 100 | |
| 32APSK | | | | | | | 100 |

To model identification of the modulation type under more realistic detection conditions, a squared root-raised cosine (SRRC) pulse-shaping matched filter was modeled as part of the detector, with 2 samples per baseband symbol. As a result of this change, the expected ranges for the set of cumulant-based measures changed slightly from the ideal ranges used to model results shown in Tables 3-5. The confusion matrices for 5 dB and 15 dB incoming signals with SRRC matched filtering during detection are shown in Tables 6 and 7, respectively.

TABLE 6

| Modulation | BPSK | QPSK | 8PSK | 8QAM | 16QAM | 16APSK | 32APSK |
|---|---|---|---|---|---|---|---|
| BPSK | 100 | | | | | | |
| QPSK | | 100 | | | | | |
| 8PSK | | 2.3 | 97.7 | | | | |
| 8QAM | | | | 100 | | | |
| 16QAM | | | | | 100 | | |
| 16APSK | | | | | | 100 | |
| 32APSK | | | | | | | 100 |

TABLE 7

| Modulation | BPSK | QPSK | 8PSK | 8QAM | 16QAM | 16APSK | 32APSK |
|---|---|---|---|---|---|---|---|
| BPSK | 100 | | | | | | |
| QPSK | | 100 | | | | | |
| 8PSK | | | 100 | | | | |
| 8QAM | | | | 100 | | | |
| 16QAM | | | | | 100 | | |
| 16APSK | | | | | | 100 | |
| 32APSK | | | | | | | 100 |

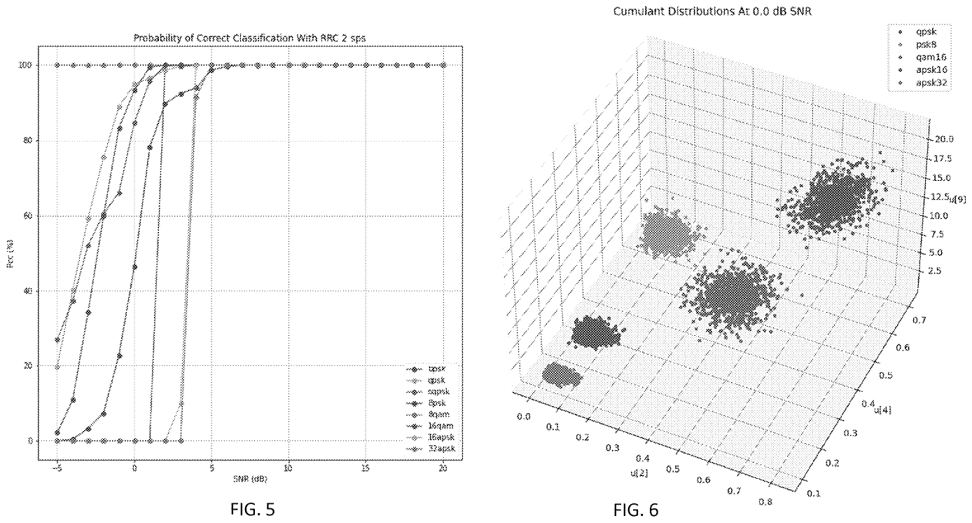

It was observed that under conditions where symbol timing corrections were performed as described above (so that symbol timing was nearly ideal) and polyphase matched SRRC filtering was performed, nearly 100% identification of the signal's modulation type was achieved for SNRs down to −2 dB. FIG. 5 is a graph showing the probability of correct identification of modulation under the above conditions as a function of SNR for the incoming symbol stream. As is evident from the plot, for SNRs of 5 dB or greater, the probability of a correct identification of the signal modulation is very high.

It was observed that in some embodiments, certain modulation types are relatively highly associated with (i.e., clustered around) certain combinations of cumulant-based measures. If these modulation types are regarded as classes in a classification scheme, well-defined clusters associated with these classes are sometimes observed to form, depending on the particular set of cumulant-based measures that are selected.

FIG. 6 is a three-dimensional plot with dots representing identified modulation types for test signals. The candidate modulation types were those shown in Table 1, and modulation types were identified using the hierarchical decision procedure described above. Values of the u[2], u[4], and u[9] elements of the feature vector (as defined by Equation (20)) are shown on the three axes. As is evident from the plot, five of the modulation types appear as well-defined clusters largely separated from one another in the three-dimensional cumulant space defined by u[2], u[4], and u[9].

### Hardware and Software Implementation

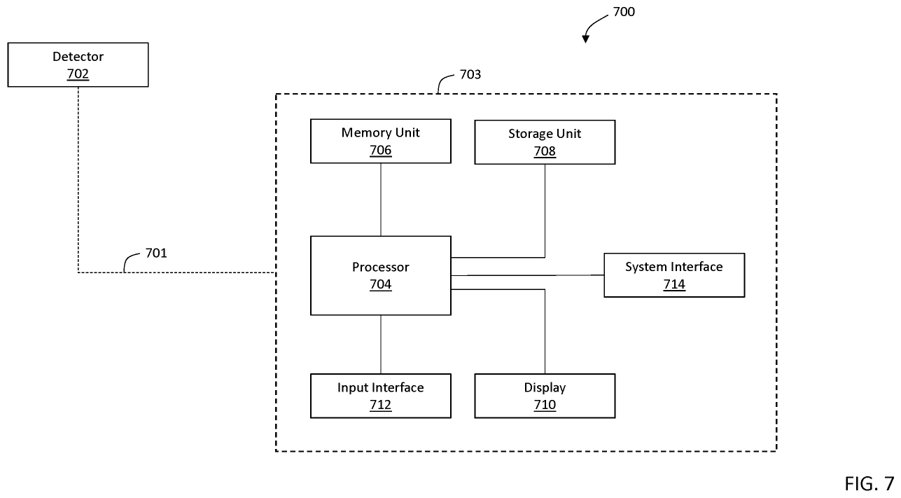

The methods described herein can be performed using detection systems that incorporate a wide variety of different hardware components. FIG. 7 shows one example of a suitable detection system 700 for executing the procedures discussed above. System 700 includes a detector 702 that is coupled to a controller 703 that includes a processor 704, a memory unit 706, a storage unit 708, a display 710, an input interface 712, and a system interface 714. It should be understood that implementations of controller 703 can also include any one or more of the above components in multiplicity. For example, controller 703 can include multiple processors 704, multiple memory units 706, multiple storage units 708, multiple system interfaces 714, etc. Merely to simplify the discussion below, each of the above elements is referred to as a single element.

Controller 703 is coupled to detector 702 via a communication interface 701. Interface 701 can be a physical, wired interface (i.e., one or more communication lines). Alternatively, interface 701 can be a wireless connection between detector 702 and controller 703. Still further, in some embodiments, a combination of wired and wireless interfaces between detector 702 and controller 703 form communication interface 701.

Detector 702 can be implemented in a variety of ways. In general, detector 702 includes hardware components suitable for receiving a stream of symbols from a symbol constellation, and converting the symbol stream into a signal that is processed by controller 703. Suitable detectors for this purpose include, but are not limited to, one or more antennas, including phased arrays of antennas.

Processor 704 can process instructions for execution within the controller 703, including instructions stored in the memory unit 706 or in the storage unit 708. For example, the instructions can instruct processor 704 to perform any of the various steps described herein.

Memory unit 706 can store executable instructions for processor 704, information about parameters of the system and of the symbol stream (such as estimated values of the parameters determined in the various methods described herein). Storage unit 708 can be a computer-readable medium, such as a floppy disk device, a hard disk device, an optical disk device, or a tape device, a flash memory or other similar solid state memory device, or an array of devices, including devices in a storage area network or other configurations. Storage device 708 can store instructions that can be executed by processor 704 as described above, and any of the other information that can be stored by memory unit 706.

In some embodiments, controller 703 can include a graphics processing unit to display graphical information (e.g., using a GUI or text interface) on an external input/output device, such as display 710. A user can use input devices (e.g., keyboard, pointing device, touch screen, speech recognition device) as part of input interface 712 to provide input to controller 703. In some embodiments, one or more such devices are part of input interface 712.

The methods disclosed herein can be implemented by controller 703 by executing instructions in one or more computer programs that are executable and/or interpretable by controller 703, and specifically, by processor 704 of controller 703. These computer programs (also known as software, software applications or code) include machine instructions for a programmable processor, and can be implemented in a high-level procedural and/or object-oriented programming language, and/or in assembly/machine language. For example, computer programs can contain the instructions that can be stored in memory unit 706, in storage unit 708, and/or on a tangible, computer-readable medium, and executed by processor 704 as described above. As used herein, the term “computer-readable medium” refers to any computer program product, apparatus and/or device (e.g., magnetic discs, optical disks, memory, programmable logic devices (PLDs), application-specific integrated circuits (ASICs), and electronic circuitry) used to provide machine instructions and/or data to a programmable processor, including a machine-readable medium that receives machine instructions.

By executing instructions as described above (which can optionally be part of controller 703), the controller can be configured to implement any one or more of the various steps described in connection with any of the procedures discussed herein.

### OTHER EMBODIMENTS

While certain embodiments of the present disclosure have been shown and described herein, it will be obvious to those skilled in the art that such embodiments are provided by way of example only. Numerous variations, changes, and substitutions will be apparent to those skilled in the art. It should be understood that various alternatives to the embodiments specifically described herein are within the scope of this disclosure.

What is claimed is:

1. A system, comprising:
a receiver configured to detect signals corresponding to a stream of digital symbols;
a signal decoder for processing the stream of digital symbols; and
a computing device connected to the receiver and comprising a set of software instructions that, when executed by the computing device, causes the computing device to:
identify a modulation type associated with the stream of digital symbols by:
computing values of a set of cumulant-based measures for at least a subset of the stream of digital symbols;
comparing the computed values to expected ranges for the set of cumulant-based measures for a plurality of candidate modulation types; and
blindly identifying the modulation type associated with the stream of digital symbols from among the candidate modulation types based on the comparison;
transmit a control signal to the signal decoder to configure the signal decoder based on the identified modulation type to process the stream of digital symbols; and
use the configured signal decoder to decode at least a portion of the stream of digital symbols to extract encoded information based on the identified modulation type.

2. The system of claim 1, wherein blindly identifying the modulation type associated with the stream of digital symbols comprises, for each modulation type of the plurality of candidate modulation types, excluding the modulation type if any of the computed values of the cumulant-based measures is outside a corresponding range of expected values for the modulation type.

3. The system of claim 1, wherein blindly identifying the modulation type associated with the stream of digital symbols comprises identifying among the plurality of candidate modulation types a single modulation type associated with the stream of digital symbols.

4. The system of claim 1, wherein blindly identifying the modulation type associated with the stream of digital symbols comprises identifying among the plurality of candidate modulation types a set of candidate modulation types, and wherein the set of candidate modulation types comprises fewer members than the plurality of candidate modulation types.

5. The system of claim 4, wherein the set of candidate modulation types comprises three or fewer members.

6. The system of claim 1, wherein the set of cumulant-based measures comprises one or more measures based on fourth-order cumulants.

7. The system of claim 1, wherein the set of cumulant-based measures comprises one or more measures based on sixth-order cumulants.

8. The system of claim 1, wherein the set of cumulant-based measures comprises one or more measures based on eighth-order cumulants.

9. The system of claim 1, wherein the plurality of candidate modulation types comprises at least 3 different modulation types.

10. The system of claim 9, wherein the plurality of candidate modulation types comprises at least 7 different modulation types.

11. The system of claim 1, wherein the plurality of candidate modulation types comprises one or more modulation types that correspond to phase-shift keying modulation.

12. The system of claim 1, wherein the plurality of candidate modulation types comprises one or more modulation types that correspond to quadrature amplitude modulation.

13. The system of claim 1, wherein the plurality of candidate modulation types comprises BPSK, QPSK, 8PSK, 16APSK, 32APSK, 8QAM, and 16QAM modulation types.

14. The system of claim 1, wherein the set of cumulant-based measures comprises at least 3 different cumulant-based measures.

15. The system of claim 14, wherein the set of cumulant-based measures comprises at least 10 different cumulant-based measures.

16. The system of claim 1, wherein at least one of the cumulant-based measures comprises a magnitude of a cumulant value computed for the at least a subset of the stream of digital symbols.

17. The system of claim 1, wherein at least one of the cumulant-based measures comprises a ratio of magnitudes of different cumulant values computed for the at least a subset of the stream of digital symbols.

18. The system of claim 1, wherein at least one of the cumulant-based measures comprises a value of a linear function of a cumulant computed for the at least a subset of the stream of digital symbols.

19. The system of claim 1, wherein at least one of the cumulant-based measures comprises a value of a nonlinear function of a cumulant computed for the at least a subset of the stream of digital symbols.

20. A method, comprising:
detecting signals corresponding to a stream of digital symbols;
computing values of a set of cumulant-based measures for at least a subset of the stream of digital symbols;
comparing the computed values to expected ranges for the set of cumulant-based measures for a plurality of candidate modulation types;
identifying a modulation type associated with the stream of digital symbols from among the candidate modulation types based on the comparison;
configuring a signal decoder to configure the signal decoder based on the identified modulation type to process the stream of digital symbols; and
using the configured signal decoder to decode at least a portion of the stream of digital symbols to extract encoded information based on the identified modulation type.

21. The method of claim 20, wherein identifying the modulation type associated with the stream of digital symbols comprises, for each modulation type of the plurality of candidate modulation types, excluding the modulation type if any of the computed values of the cumulant-based measures is outside a corresponding range of expected values for the modulation type.

22. The method of claim 20, wherein identifying the modulation type associated with the stream of digital symbols comprises identifying among the plurality of candidate modulation types a single modulation type associated with the stream of digital symbols.

23. The method of claim 20, wherein identifying the modulation type associated with the stream of digital symbols comprises identifying among the plurality of candidate modulation types a set of candidate modulation types, and wherein the set of candidate modulation types comprises fewer members than the plurality of candidate modulation types.

24. The method of claim 23, wherein the set of candidate modulation types comprises three or fewer members.

25. The method of claim 20, wherein the set of cumulant-based measures comprises one or more measures based on fourth-order cumulants.

26. The method of claim 20, wherein the set of cumulant-based measures comprises one or more measures based on sixth-order cumulants.

27. The method of claim 20, wherein the set of cumulant-based measures comprises one or more measures based on eighth-order cumulants.

28. The method of claim 20, wherein the plurality of candidate modulation types comprises at least 3 different modulation types.

29. The method of claim 28, wherein the plurality of candidate modulation types comprises at least 7 different modulation types.

30. The method of claim 20, wherein the plurality of candidate modulation types comprises one or more modulation types that correspond to phase-shift keying modulation.

31. The method of claim 20, wherein the plurality of candidate modulation types comprises one or more modulation types that correspond to quadrature amplitude modulation.

32. The method of claim 20, wherein the plurality of candidate modulation types comprises BPSK, QPSK, 8PSK, 16APSK, 32APSK, 8QAM, and 16QAM modulation types.

33. The method of claim 20, wherein the set of cumulant-based measures comprises at least 3 different cumulant-based measures.

34. The method of claim 33, wherein the set of cumulant-based measures comprises at least 10 different cumulant-based measures.

35. The method of claim 20, wherein at least one of the cumulant-based measures comprises a magnitude of a cumulant value computed for the at least a subset of the stream of digital symbols.

36. The method of claim 20, wherein at least one of the cumulant-based measures comprises a ratio of magnitudes of different cumulant values computed for the at least a subset of the stream of digital symbols.

37. The method of claim 20, wherein at least one of the cumulant-based measures comprises a value of a linear function of a cumulant computed for the at least a subset of the stream of digital symbols.

38. The method of claim 20, wherein at least one of the cumulant-based measures comprises a value of a nonlinear function of a cumulant computed for the at least a subset of the stream of digital symbols.

39. A system, comprising:
a receiver configured to detect signals corresponding to a stream of digital symbols;
a signal decoder for processing the stream of digital symbols; and
a computing device connected to the receiver and comprising a set of software instructions that, when executed by the computing device, causes the computing device to:
identify a modulation type associated with the stream of digital symbols by:
computing values of a set of cumulant-based measures for at least a subset of the stream of digital symbols;
constructing a feature vector associated with the at least a subset of the stream of digital symbols, wherein elements of the feature vector correspond to the set of cumulant-based measures; and
identifying the modulation type associated with the stream of digital symbols from among the candidate modulation types by submitting the feature vector to a trained classifier that generates as output the modulation type associated with the stream of digital symbols;
transmit a control signal to the signal decoder to configure the signal decoder based on the identified modulation type to process the stream of digital symbols; and
use the configured signal decoder to decode at least a portion of the stream of digital symbols to extract encoded information based on the identified modulation type.
